(19) United States
(12) Patent Application Publication
(10) Pub. No.: US 2018/0007864 A1
(43) Pub. Date: Jan. 11, 2018

(54) Animal Garment Assembly

(71) Applicant: Jamii Armstrong, Etowah, NC (US)

(72) Inventor: Jamii Armstrong, Etowah, NC (US)

(21) Appl. No.: 15/205,073

(22) Filed: Jul. 8, 2016

(51) Int. Cl. A01K 13/00; A44B 18/00

(52) U.S. Cl. CPC A01K 13/006; A44B 18/00

(57) ABSTRACT

An animal garment assembly includes a garment that may be worn on a male animal. The garment has a pair of wings. The male animal's genitalia are exposed when the garment is worn. Thus, the male animal may urinate without soiling the garment. A closure is coupled to the garment. Thus, the closure may secure the garment around the animal when the garment is worn. The closure adjustably secures the garment to facilitate a variety of sizes of animals.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

(1) Field of the Invention

(2) Description of Related Art including information disclosed under 37 CFR 1.97 and 1.98

The disclosure and prior art relates to garment devices and more particularly pertains to a new garment device for facilitating a male animal to urinate while wearing a garment.

### BRIEF SUMMARY OF THE INVENTION

An embodiment of the disclosure meets the needs presented above by generally comprising a garment that may be worn on a male animal. The garment has a pair of wings. The male animal's genitalia are exposed when the garment is worn. Thus, the male animal may urinate without soiling the garment. A closure is coupled to the garment. Thus, the closure may secure the garment around the animal when the garment is worn. The closure adjustably secures the garment to facilitate a variety of sizes of animals.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an animal garment assembly according to an embodiment of the disclosure.

FIG. 2 is a front view of an embodiment of the disclosure.

FIG. 3 is a back view of an embodiment of the disclosure.

FIG. 4 is a perspective in-use view of an embodiment of the disclosure.

FIG. 5 is a bottom perspective in-use view of an embodiment of the disclosure.

### DETAILED DESCRIPTION OF THE INVENTION

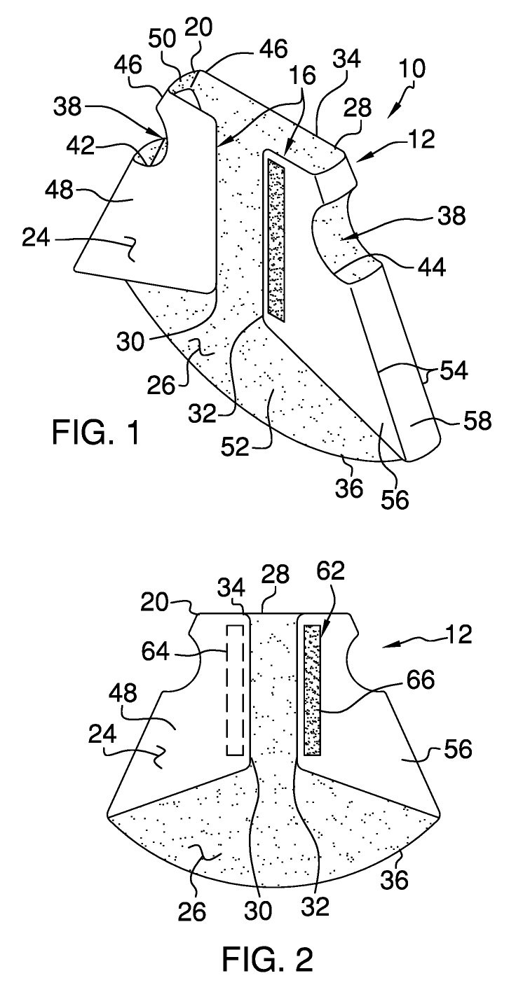

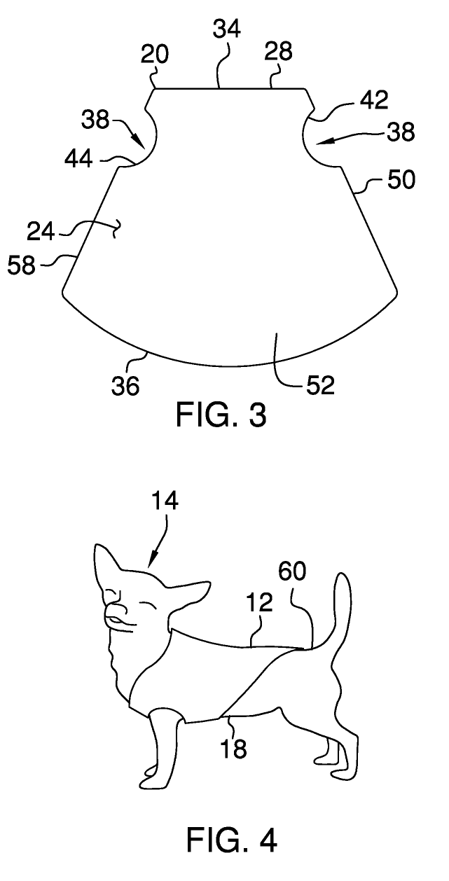

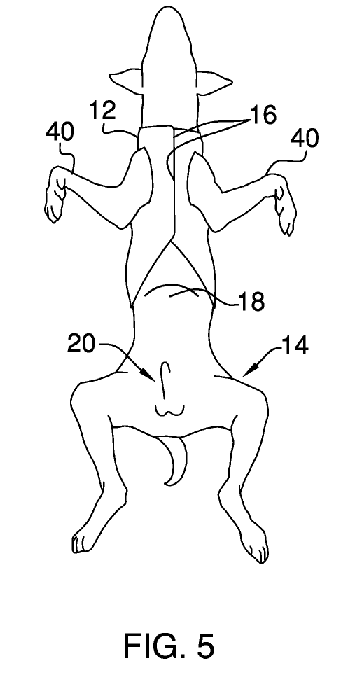

With reference now to the drawings, and in particular to FIGS. 1 through 5 thereof, a new garment device embodying the principles and concepts of an embodiment of the disclosure and generally designated by the reference numeral 10 will be described.

As best illustrated in FIGS. 1 through 5, the animal garment assembly 10 generally comprises a garment 12 that may be worn on a male animal 14. The male animal 14 may be a small breed dog or the like. The garment 12 has a pair of wings 16. The wings 16 wrap around the male animals stomach 18. The male animal's genitalia 20 are exposed when the garment 12 is worn. Thus, the male animal 14 may urinate without soiling the garment 12.

The garment 12 comprises a panel 22 that has a first surface 24, a second surface 26 and a peripheral edge 28 extending therebetween. The peripheral edge 28 has a first lateral side 30, a second lateral side 32, a front side 34 and a back side 36. The panel 22 has a pair of leg openings 38 extending through the first surface 24 and the second surface 26. Each of the leg openings 38 insertably receives an associated one of a pair of front legs 40 of the male animal 14. The panel 22 may be comprised of a flexible material. Additionally, the panel 22 may be comprised of a thermally insulating material.

Each of the leg openings 38 is positioned closer to the front side 34 than the back side 36. The leg openings 38 are spaced apart from each other. Each of the leg openings 38 may have an ovoid shape. Moreover, the pair of leg openings 38 includes a first leg opening 42 and a second leg opening 44.

The panel 22 includes a pair of first bends 46 and each of the first bends 46 extends between the front side 34 and the back side 36. Each of the first bends 46 is positioned closer to the first lateral side 30 than the second lateral side 32. The first bends 46 are spaced apart from each other to define a first one of the wings 48, first lateral portion 50 and a body portion 52 of the panel 22.

The first wing 48 is spaced from the second surface 26 corresponding to the body portion 52. The first leg opening 42 extends through the first lateral portion 50. The first wing 48 may wrap downwardly around the male animal's stomach 18 when the garment 12 is worn. The back side 36 corresponding to the first wing 48 angles toward the front side 34 between the first lateral portion 50 and the first lateral side 30. Thus, the first wing 48 exposes the male animals' genitalia 20 when the first wing 48 is wrapped around the male animal's stomach 18.

The panel 22 includes a pair of second bends 54 and each of the second bends 54 extends between the front side 34 and the back side 36. Each of the second bends 54 is positioned closer to the second lateral side 32 than the first lateral side 30. The second bends 54 are spaced apart from each other to define a second one of the wings 56, a second lateral portion 58 and the body portion 52.

The second wing 56 is spaced from the second surface 26 corresponding to the body portion 52. The second leg opening 44 extends second lateral portion 58. The second wing 56 may wrap downwardly around the animal's stomach 18 when the garment 12 is worn. Moreover, the first lateral side 30 is aligned with the second lateral side 32 when the garment 12 is worn.

The back side 36 corresponding to the second wing 56 angles toward the front side 34 between the second lateral portion 58 and the second lateral side 32. Thus, the second wing 56 may expose the male animal 14's genitalia 20 when the second wing 56 is wrapped around the male animals' stomach 18. The back side 36 corresponding to the body portion 52 is convexly arcuate with respect to the front side 34 between the first lateral portion 50 and the second lateral portion 58. The body portion 52 may cover the male animal's back 60 when the garment 12 is worn.

A closure 62 is provided and the closure 62 is coupled to the garment 12. Thus, the closure 62 secures the garment 12 around the animal when the garment 12 is worn. The closure 62 adjustably secures the garment 12. Thus, the garment 12 may facilitate a variety of sizes of animals.

The closure 62 comprises a first fastener 64. The first fastener 64 is coupled to the first surface 24 corresponding to the first wing 48. The first fastener 64 is coextensive with the first lateral side 30. The closure 62 comprises a second fastener 66. The second fastener 66 is coupled to the second surface 26 corresponding to the second wing 56.

The second fastener 66 is coextensive with the second lateral side 32. The second fastener 66 is complementary with respect to the first fastener 64. Thus, each of the first fastener 64 and the second fastener 66 may retain the garment 12 on the animal. Each of the first fastener 64 and the second fastener 66 may comprise a hook and loop fastener or the like.

In use, the garment 12 is worn to facilitate the male animal 14 to be kept warm. Each of the male animal's front legs 40 is extended through an associated one of the leg openings 38. The body portion 52 is positioned to extend substantially along the male animal's back 60. Each of the first wing 48 and the second wing 56 are wrapped around the male animal's stomach 18. The first closure 62 is manipulated to engage the second closure 62. The back side 36 corresponding to each of the first wing 48 and the second wing 56 extends forwardly from the male animal's genitalia 20 when the garment 12 is worn. Thus, the male animal 14 may urinate when the garment 12 is worn without soiling the garment 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An animal garment assembly being configured to facilitate a male animal to urinate without soiling said assembly, said assembly comprising:
a garment being configured to be worn on a male animal, said garment having a pair of wings wherein said garment is configured to expose genitalia of the male animal thereby facilitating the male animal to urinate without soiling said garment; and
a closure being coupled to said garment wherein said closure is configured to secure said garment around the animal when said garment is worn, said closure adjustably securing said garment wherein said garment is configured to facilitate a variety of sizes of animals.

2. The assembly according to claim 1, wherein said garment comprises a panel having a first surface, a second surface and a peripheral edge extending therebetween, said peripheral edge having a first lateral side, a second lateral side, a front side and a back side, said panel having a pair of leg openings extending through said first surface and said second surface wherein each of said leg openings is configured to insertably receive an associated one of a pair of front legs of the male animal, each of said leg openings being positioned closer to said front side than said back side, said leg openings being spaced apart from each other, said pair of leg openings including a first leg opening and a second leg opening.

3. The assembly according to claim 2, further comprising a pair of first bends, each of said first bends extending between said front side and said back side, each of said first bends being positioned closer to said first lateral side than said second lateral side, said first bends being spaced apart from each other to define a first one of said wings, a first lateral portion and a body portion of said panel, said first wing being spaced from said second surface corresponding to said body portion.

4. The assembly according to claim 3, wherein said first leg opening extends through said first lateral portion, said first wing being configured to wrap downwardly around the male animal's stomach when said garment is worn, said back side corresponding to said first wing angling toward said front side between said first lateral portion and said first lateral side wherein said first wing is configured to expose the male animals' genitalia when said first wing is wrapped around the male animal's stomach.

5. The assembly according to claim 2, further comprising a pair of second bends, each of said second bends extending between said front side and said back side, each of said second bends being positioned closer to said second lateral side than said first lateral side, said second bends being spaced apart from each other to define a second one of said wings, a second lateral portion and said body portion, said second wing being spaced from said second surface corresponding to said body portion.

6. The assembly according to claim 5, wherein said second leg opening extends through said second lateral portion, said second wing being configured to wrap downwardly around the animal's stomach when said garment is worn having said first lateral edge being aligned with said second lateral edge, said back side corresponding to said second wing angling toward said front side between said second lateral portion and said second lateral side wherein said second wing is configured to expose the male animal's genitalia when said second wing is wrapped around the male animals' stomach.

7. The assembly according to claim 6, wherein said back side corresponding to said body portion being convexly arcuate with respect to said front side between a first lateral portion and said second lateral portion, said body portion being configured to cover the male animal's back when said garment is worn.

8. The assembly according to claim 3, wherein said closure comprises a first fastener being coupled to said first surface corresponding to said first wing, said first fastener being coextensive with said first lateral side.

9. The assembly according to claim 5, wherein:
said closure includes a first fastener; and
a second fastener being coupled to said second surface corresponding to said second wing, said second fastener being coextensive with said second lateral side, said second fastener being complementary with respect to said first fastener wherein each of said first fastener and said second fastener is configured to retain said garment on the animal.

10. An animal garment assembly being configured to facilitate a male animal to urinate without soiling said assembly, said assembly comprising:
a garment being configured to be worn on a male animal, said garment having a pair of wings wherein said garment is configured to expose genitalia of the male animal thereby facilitating the male animal to urinate without soiling said garment, said garment comprising:
a panel having a first surface, a second surface and a peripheral edge extending therebetween, said peripheral edge having a first lateral side, a second lateral side, a front side and a back side, said panel having a pair of leg openings extending through said first surface and said second surface wherein each of said leg openings is configured to insertably receive an associated one of a pair of front legs of the male animal, each of said leg openings being positioned closer to said front side than said back side, said leg openings being spaced apart from each other, said pair of leg openings including a first leg opening and a second leg opening, a pair of first bends, each of said first bends extending between said front side and said back side, each of said first bends being positioned closer to said first lateral side than said second lateral side, said first bends being spaced apart from each other to define a first one of said wings, a first lateral portion and a body portion of said panel, said first wing being spaced from said second surface corresponding to said body portion, said first leg opening extending through said first lateral portion, said first wing being configured to wrap downwardly around the male animal's stomach when said garment is worn, said back side corresponding to said first wing angling toward said front side between said first lateral portion and said first lateral side wherein said first wing is configured to expose the male animals' genitalia when said first wing is wrapped around the male animal's stomach, and
a pair of second bends, each of said second bends extending between said front side and said back side, each of said second bends being positioned closer to said second lateral side than said first lateral side, said second bends being spaced apart from each other to define a second one of said wings, a second lateral portion and said body portion, said second wing being spaced from said second surface corresponding to said body portion, said second leg opening extending second lateral portion, said second wing being configured to wrap downwardly around the animal's stomach when said garment is worn having said first lateral edge being aligned with said second lateral edge, said back side corresponding to said second wing angling toward said front side between said second lateral portion and said second lateral side wherein said second wing is configured to expose the male animal's genitalia when said second wing is wrapped around the male animals' stomach, said back side corresponding to said body portion being convexly arcuate with respect to said front side between said first lateral portion and said second lateral portion, said body portion being configured to cover the male animal's back when said garment is worn; and
a closure being coupled to said garment wherein said closure is configured to secure said garment around the animal when said garment is worn, said closure adjustably securing said garment wherein said garment is configured to facilitate a variety of sizes of animals, said closure comprising:
a first fastener being coupled to said first surface corresponding to said first wing, said first fastener being coextensive with said first lateral side, and
a second fastener being coupled to said second surface corresponding to said second wing, said second fastener being coextensive with said second lateral side, said second fastener being complementary with respect to said first fastener wherein each of said first fastener and said second fastener is configured to retain said garment on the animal.
